(19) United States
(12) Patent Application Publication
(10) Pub. No.: US 2017/0289153 A1
(43) Pub. Date: Oct. 5, 2017

(54) SECURE ARCHIVAL AND RECOVERY OF MULTIFACTOR AUTHENTICATION TEMPLATES

(71) Applicant: Intel Corporation, Santa Clara, CA (US)

(72) Inventors: Michael Raziel, Jerusalem (IL); Abhilasha Bhargav-Spantzel, Santa Clara, CA (US); Hormuzd M. Khosravi, Portland, OR (US); Ned M. Smith, Beaverton, OR (US)

(21) Appl. No.: 15/089,070

(22) Filed: Apr. 1, 2016

(51) Int. Cl. H04L 29/06

(52) U.S. Cl. CPC H04L 63/0876; H04L 63/0869; H04L 63/0853; H04L 63/061

(57) ABSTRACT

Systems, apparatuses and methods may provide for generating, at a computing device, a challenge message in response to a recovery request and conducting a verification of one or more responses to the challenge message based on an encryption key stored in a hardware-based trusted execution environment (TEE) of the computing device. Additionally, an authentication template associated with a multifactor authentication service may be unlocked if the verification is successful.

### TECHNICAL FIELD

Embodiments generally relate to data security. More particularly, embodiments relate to the secure archival and recovery of multifactor authentication templates.

### BACKGROUND

In computing systems, authentication solutions such as biometrics, passwords and PINs (personal identification numbers) may be used to prevent unauthorized access to various resources, applications and/or services. In order for a user to retrieve and/or reset an authentication factor (e.g., due to a forgotten password, biometric scanning errors, etc.) a validation process such as, for example, one or more security questions, may be used. Thus, the receipt of correct responses to the security questions may cause the validation process to release or reset the authentication factor. The validation process itself, however, may also be subject to “back door” and/or denial-of-service attacks. For example, malware may gain access to the security questions and/or the correct responses as well as the authentication factors themselves in some circumstances. Accordingly, failure to adequately protect stored copies of authentication factors, records and/or templates during retrieval/reset may render the primary authentication solution meaningless.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a computing device having an archival recovery apparatus according to an embodiment;

FIG. 2 is a flowchart of an example of a method of operating an archival recovery apparatus according to an embodiment;

FIG. 3 is a messaging diagram of an example of backend-assisted online and offline retrieval scenarios according to embodiments;

FIG. 4 is a messaging diagram of an example of a peer device-assisted offline retrieval scenario according to an embodiment;

FIG. 5 is a block diagram of an example of an archival recovery apparatus according to an embodiment;

FIG. 6 is a block diagram of an example of a processor according to an embodiment; and

FIG. 7 is a block diagram of an example of a computing system according to an embodiment.

### DESCRIPTION OF EMBODIMENTS

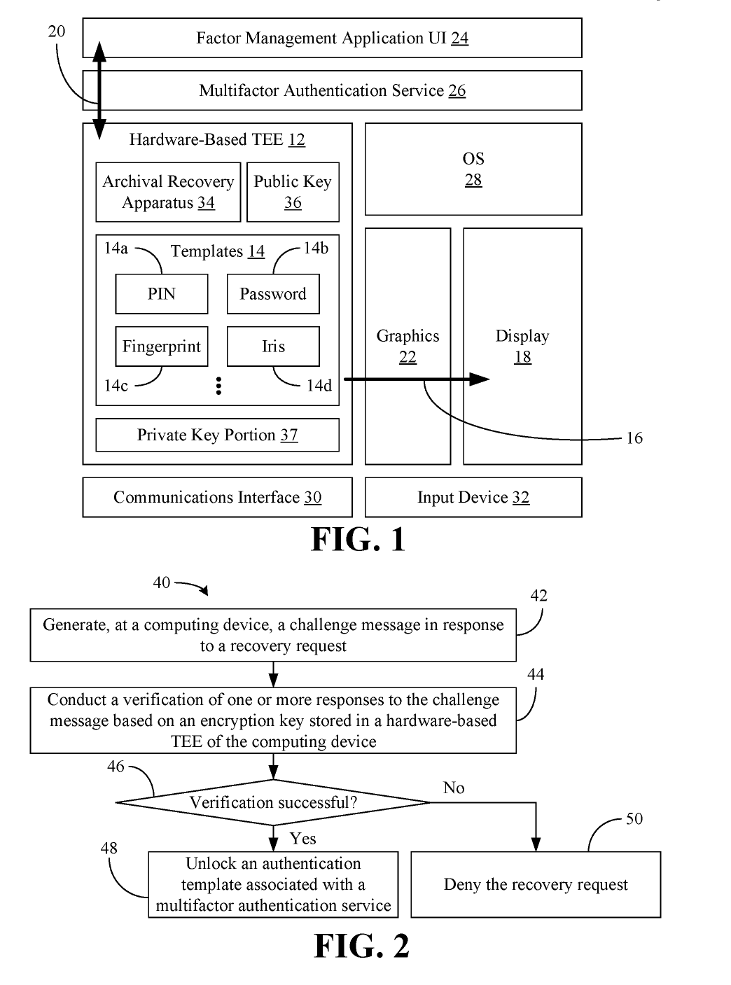

Turning now to FIG. 1, an authentication-enabled computing device 10 (e.g., kiosk, notebook computer, smart tablet, convertible tablet, smart phone, personal digital assistant/PDA, mobile Internet device/MID, media player, mobile platform, handheld device, game console, wearable computer, etc., or any combination thereof) is shown in which a hardware-based trusted execution environment (TEE) 12 stores/archives one or more authentication templates 14 (14a-14d, e.g., records/factors) that facilitate the authentication of a user of the computing device 10 in conjunction with the access of one or more resources, applications and/or services (e.g., local or remote). For example, the templates 14 might include a PIN (personal identification number) template 14a that documents a previously established (e.g., recorded, selected, enrolled and/or registered) PIN, a password template 14b that documents a previously established password, a fingerprint template that documents a previously enrolled/registered fingerprint of the user, an iris template 14d that documents a previously enrolled/registered iris of the user, and so forth.

The hardware-based TEE 12 may generally be a secure area that resides in a host processor (not shown) and protects code and data loaded inside the TEE 12 with respect to confidentiality and integrity. For example, the hardware-based TEE 12 may protect the templates 14 from untrusted software such as an operating system (OS) 28, which might include malware. As will be discussed in greater detail, the hardware-based TEE 12 may establish a trusted path 16 to a display 18 of the computing device as well as a trusted path 20 to a factor management application user interface (UI) 24. The trusted paths 16, 20 may facilitate authentication of a user of the computing device 10 prior to recovering one or more of the templates 14 (e.g., for retrieval and/or updating due to lost or forgotten information). In one example, the trusted path 16 includes at least a portion of a graphics subsystem 22 and the trusted path 20 includes at least a portion of a multifactor authentication (MFA) service 26. In one example, the trusted path 16 is implemented as an INTEL Protected Transaction Display (PTD), although other techniques may also be used. Other components such as, for example, a communications interface 30 (e.g., wireless controller) and/or input device 32 (e.g., mouse, touch pad) may also be used to authenticate the user in conjunction with a request to recover one or more of the templates 14.

In general, a recovery request may trigger either an online authentication sequence or an offline authentication sequence. The online authentication sequence may be triggered if, for example, the communications interface 30 of the computing device 10 has connectivity to one or more backend consoles (e.g., executing on remote servers operated by help desk personnel, not shown). Thus, the online authentication sequence may be considered to be “backend-assisted”. If the computing device 10 does not have connectivity to one or more backend consoles, the offline authentication sequence may be triggered. In this regard, the computing device 10 may have “indirect” connectivity to the backend consoles by virtue of a connection to help desk personnel (e.g., via voice call, chat connection, etc.) who have access to the backend console(s). Therefore, at least one example of the offline authentication sequence may also be considered to be backend-assisted. If the computing device 10 has neither direct nor indirect connectivity to one or more backend consoles, the offline authentication sequence may instead be peer device-assisted, as will be discussed in greater detail.

More particularly, a recovery request may be received from a user of the computing device 10 via the UI 24, wherein the recovery request may be to unlock, retrieve and/or update one or more of the templates 14 (e.g., due to a forgotten password, biometric scanning errors, etc.). The illustrated hardware-based TEE 12 includes an archival recovery apparatus 34 that generates, at the computing device 10, a challenge message in response to the recovery request. If backend assistance is available (e.g., either directly or indirectly), the challenge message may be presented on the display 18 via the trusted path 16. Presenting the challenge message, which might be a number, alphanumeric code, etc., via the trusted path 16 may involve using the graphics subsystem 22 to generate an image of the challenge message and showing the image in a protected area (e.g., graphics sprite) of the display 18. In such a case, the challenge message is inaccessible by the OS 28 and/or other untrusted software on the computing device 10. Indeed, the challenge message may not be visible to help desk personnel having remote access to the computing device 10 because the protected area is only visible on the display 18 of the computing device 10.

In the case of backend-assisted recovery, the user of the computing device 10 may read the challenge message aloud to the help desk personnel, who may in turn enter (e.g., after verifying one or more other authentication factors of the user) the challenge message into one or more backend consoles. The backend consoles may use a private key to generate one or more responses to the challenge message, wherein the private key is associated with a public key 36 stored in the hardware-based TEE 12.

If backend assistance is not available (e.g., either directly or indirectly), the challenge message may be transmitted (e.g., via a proximity-based out-of-band/00B communication link) to a plurality of peer devices. In one example, the challenge message is transmitted to the peer devices via the communications interface 30. A portion of a private key may be stored on each of the peer devices, wherein the private key portions are associated with the public key 36 and each peer device may use a respective private key portion to generate and return a response to the challenge message.

Thus, the archival recovery apparatus 34 may receive and verify one or more responses to the challenge message in a number of different ways, depending on the circumstances: backend-assisted online recovery, backend-assisted offline recovery, peer device-assisted offline recovery.

Backend-Assisted Online Recovery

Once the user verbally reads the challenge message to the help desk personnel and the personnel enter the challenge message into the backend console(s), the console(s) may generate and transmit the response(s) to the computing device 10 via, for example, the communications interface 30. In such a case, the archival recovery apparatus 34 may use the public key 36 to verify the authenticity of the response(s). If the verification is successful, the archival recovery apparatus 34 may unlock the template 14 in question, permit the user to retrieve the unlocked template 14, assist the user in updating the unlocked template 14, and so forth.

Backend-Assisted Offline Recovery

In this scenario, the user verbally reads the challenge message to the help desk personnel and the personnel enter the challenge message into the backend console(s). Because the computing device 10 does not have, however, a connection to the backend console(s), the help desk personnel may read the one or more responses aloud to the user of the computing device 10. In such a case, a graphical keypad (e.g., having a randomized number arrangement) or other secure information entry image may be presented in a protected area (e.g., graphics sprite) of the display 18 via the trusted path 16, wherein the user of the computing device 10 may enter the response(s) via the graphical keypad. In one example, the user manipulates an input device 32 such as, for example, a mouse or touch pad, to enter the response(s) via the graphical keypad and the archival recovery apparatus 34 maps the response(s) to the protected area of display (e.g., via screen coordinates). The archival recovery apparatus 34 may use the public key 36 to verify the authenticity of the response(s), wherein if the verification is successful, the archival recovery apparatus 34 may unlock the template 14 in question for retrieval and/or update.

Peer Device-Assisted Offline Recovery

The valid user of the computing device 10 may form a secret sharing group with other peer device users. Thus, if both backend assistance and help desk assistance are unavailable, a plurality of responses may be received from a corresponding plurality of peer devices via a proximity-based 00B communication link, wherein each response includes the result of the application of a portion of a private key to the challenge message. In such a case, the verification may be conducted with respect to the plurality of responses. More particularly, the archival recovery apparatus 34 may determine whether the plurality of responses satisfy a secret sharing policy such as, for example, m out of N peer devices (e.g., six out of ten peer devices) have returned a valid response. In this regard, the user of the computing device 10 might unlock, retrieve and/or update one or more of the templates 14 without access to a help desk or backend console or concern over unauthorized access. The hardware-based TEE 12 may also store a portion 37 of a private key that may be used to participate in the secret sharing group as a peer device.

The proximity-based OOB communication link may be implemented in a variety of ways. For example, the communications interface 30 may include Bluetooth Low Energy functionality (BLE, e.g., Bluetooth Core Specification Version 4.0, Jun. 30, 2010, Bluetooth Special Interest Group/SIG), optical QR (quick response) code reading functionality (e.g., using cameras), near field communications (NFC) functionality, ultrasound functionality (e.g., using microphones and speakers), haptics functionality (e.g., using accelerometers and/or gyroscopes), personal area network/PAN functionality, and/or other components to interact with the peer devices. In this regard, the use of a proximity-based communication link (e.g., Bluetooth) may enhance security by adding a face-to-face component to the secret sharing framework.

FIG. 2 shows a method 40 of operating an archival recovery apparatus. The method 40 may generally be implemented in an apparatus such as, for example, the archival recovery apparatus 34 (FIG. 1), already discussed. More particularly, the method 40 may be implemented in one or more modules as a set of logic instructions stored in a machine- or computer-readable storage medium such as random access memory (RAM), read only memory (ROM), programmable ROM (PROM), firmware (FW), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 40 may be written in any combination of one or more programming languages, including an object oriented programming language such as JAVA, SMALLTALK, C++ or the like and conventional procedural programming languages, such as the “C” programming language or similar programming languages.

Illustrated processing block 42 provides for generating, at a computing device, a challenge message in response to a recovery request. Block 42 may include presenting the challenge message on a display of the computing device via a trusted path (e.g., in a backend-assisted recovery scenario). Block 44 may conduct a verification of one or more responses to the challenge message based on an encryption key stored in a hardware-based TEE of the computing device. As already noted, the response(s) may be received from one or more backend consoles (e.g., for an online recovery), an input device that is mapped to the screen coordinates of a protected area on the display (e.g., for a backend-assisted offline recovery), a plurality of peer devices (e.g., for a peer device-assisted offline recovery), and so forth. Block 44 may therefore include using a locally stored public key to confirm the authenticity of the one or more responses. Block 44 may also include comparing a plurality of responses to a secret sharing policy (e.g., for a peer device-assisted offline recovery).

If it is determined at block 46 that the verification was successful, illustrated block 48 unlocks an authentication template associated with an MFA service. Block 48 may include retrieving the authentication template from the hardware-based TEE, updating the authentication template in the hardware-based TEE, and so forth. In this regard, the template may be encrypted with a symmetric encryption key and stored in the hardware-based TEE, wherein the encryption key is derived from a password that is known to a help desk (for online recovery scenarios) and known by the user for offline recovery. If it is determined at block 46 that the verification was unsuccessful, block 50 may deny the recovery request.

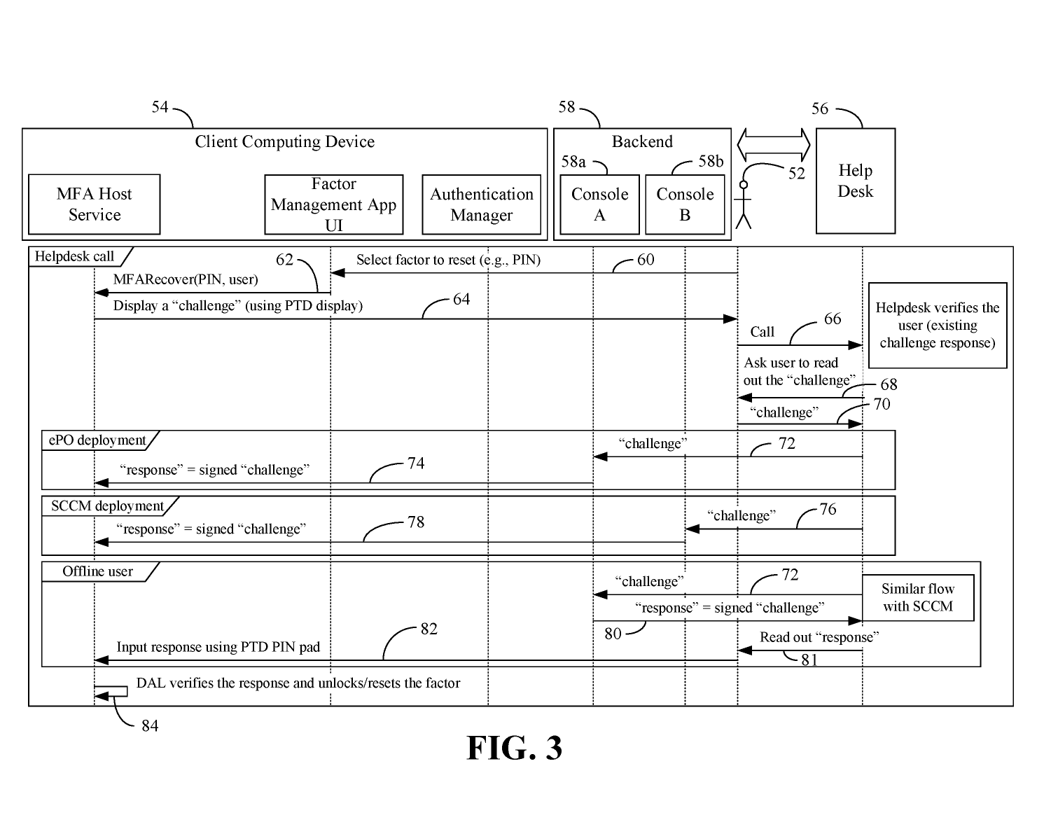

FIG. 3 shows a messaging diagram for backend-assisted online and backend-assisted offline recoveries. In the illustrated example, a user 52 operates a client computing device 54 and help desk personnel 56 may operate a backend server 58 (58a, 58b, e.g., corporate network). The user 52 may select a factor to reset (e.g., PIN) and communicate the selection to a factor management application UI in a selection message 60. In response to the selection message 60, the factor management application UI may generate a recovery message 62 that identifies an authorized user and the factor to be reset. An MFA host service and/or an authentication manager may use a command blob to generate a challenge message 64 (e.g., a nonce) that is presented to the user 52 via a trusted path to a display of the client computing device 54. The user 52 may then place a call 66 to the help desk personnel 56, wherein the help desk personnel may verify the user 52 via one or more of the other factors not being reset (e.g., password, user presence detection, video face recognition). Upon satisfactory verification of the user 52, the help desk personnel 56 may ask the user 52, in a prompt 68, to verbally read out the challenge message 64. The user may then utter the challenge message 64 in a spoken message 70.

The backend server 58 may include one or more consoles (e.g., representing different levels of technical support) such as a first console 58a (“Console A”, e.g., ePolicy Orchestrator/ePO), a second console 58a (“Console B”, e.g., System Center Configuration Manager/SCCM), and so forth. In such a case, the help desk personnel 56 might enter the challenge message into the first console 58a as a first entry 72, wherein the first console 58a signs and/or encrypts the first entry 72 (e.g., using a private key) and sends the signed/encrypted first entry 72 to the MFA host service as a first response 74. Similarly, the help desk personnel 56 may enter the challenge message into the second console 58b as a second entry 76, wherein the second console 58b signs and/or encrypts the second entry 76 (e.g., using a private key) and sends the signed/encrypted second entry 76 to the MFA host service as a second response 78.

If the client computing device 54 does not have connectivity with the backend 58 server (e.g., for a backend-assisted offline recovery), the help desk personnel 56 may enter the challenge message into the first console 58a as the first entry 72, wherein the first console 58a signs and/or encrypts the first entry 72 and presents the signed/encrypted first entry 72 to the help desk personnel 56 as a presented response 80. The help desk personnel 56 may then utter the presented response 80 to the user 52 as a spoken message 81 and the user 52 enters the spoken message 81 into the computing device 54 as an entered response 82 via an input device that is mapped to a protected area on the display of the computing device 54.

In the illustrated example, a dynamic application loader (DAL) 84 conducts a verification of the first response 74, the second response 78 and/or the entered response 82. If the verification is successful, the DAL 84 may unlock and/or reset the factor in question. Otherwise, the DAL 84 may deny the selection message 60. Accordingly, the first response 74, the second response 78 and/or the entered response 82 may function as one-time-use tokens that authorize the user 52 to re-enroll one or more of the templates 14.

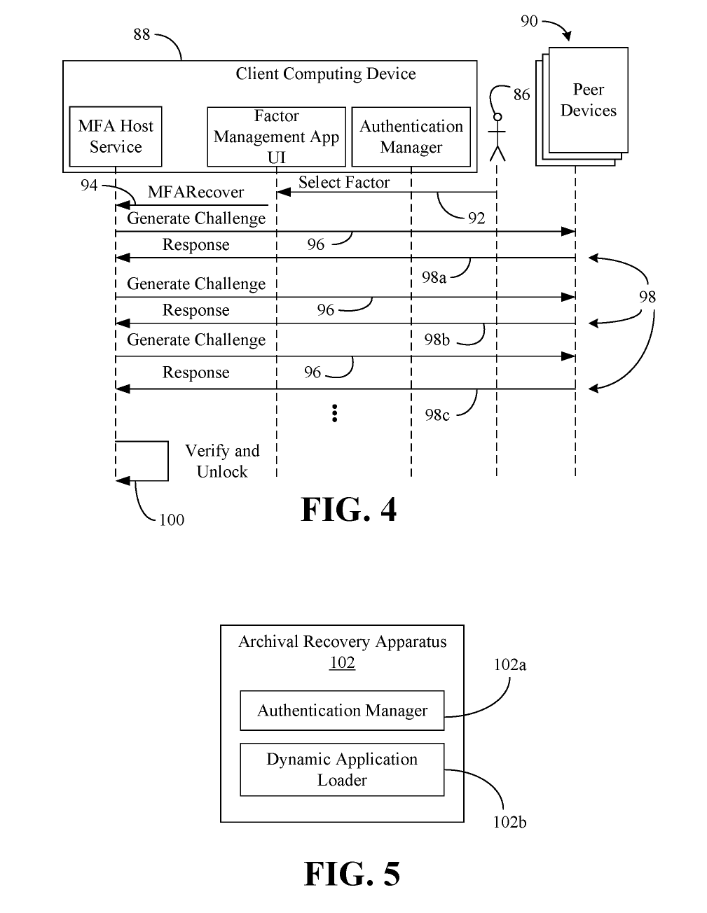

Turning now to FIG. 4, a messaging diagram for a peer device-assisted offline recovery is shown. In the illustrated example, a primary user 86 operates a client computing device 88 and a plurality of secondary users (not shown) operate a corresponding plurality of peer devices 90. The primary user 86 may select a factor to reset (e.g., fingerprint) and communicate the selection to a factor management application UI in a selection message 92. In response to the selection message 92, the factor management application UI may generate a recovery message 94 that identifies an authorized user and the factor to be reset. An MFA host service and/or an authentication manager may generate a challenge message 96 that is transmitted to two or more of the peer devices 90. For example, the primary user 86 might individually seek out the secondary users in an effort to locate enough members of a secret sharing group to unlock the factor in question. The peer devices 90 receiving the challenge message 96 may each sign and/or encrypt the challenge message 96 (e.g., using a portion of a private key) and send the signed/encrypted challenge message 96 back to the computing device 88 as a response 98 (98a-98c). The client computing device 88 may communicate with the peer devices 90 via a proximity-based 00B communication link such as, for example, a BLE, optical QR, NFC, ultrasound, haptic, and/or PAN link. A DAL 100 may conduct a verification of the responses 98 (e.g., determining whether at least m of N peers have responded) and, if the verification is successful, then the DAL 1000 may unlock and/or reset the factor in question.

FIG. 5 shows an archival recovery apparatus 102 (102a, 102b). The apparatus 102, which may include fixed-functionality logic hardware, configurable logic, logic instructions, etc., or any combination thereof, may implement one or more aspects of the method 40 (FIG. 2). Accordingly, the apparatus 102 may be readily substituted for the archival recovery apparatus 34 (FIG. 1), already discussed. In the illustrated example, the apparatus 102 includes an authentication manager 102a to generate, at a computing device, a challenge message in response to a recovery request. In one example, the authentication manager 102a presents the challenge message on a display of the computing device via a trusted path (e.g., for a backend-assisted online or offline recovery).

A dynamic application loader 102b may be communicatively coupled to the authentication manager 102a, wherein the dynamic application loader 102b is configured to conduct a verification of one or more responses to the challenge message based on an encryption key stored in a hardware-based TEE of the computing device. Additionally, the dynamic application loader 102b may unlock an authentication template associated with a multifactor authentication service if the verification is successful. The dynamic application loader 102b may deny the recovery request if the verification is not successful.

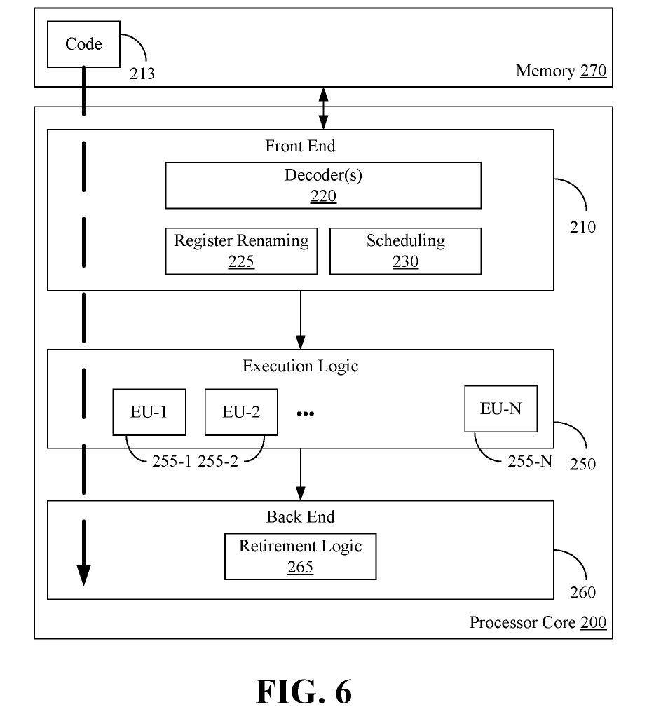

FIG. 6 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 6, a processing element may alternatively include more than one of the processor core 200 illustrated in FIG. 6. The processor core 200 may be a single-threaded core or, for at least one embodiment, the processor core 200 may be multithreaded in that it may include more than one hardware thread context (or “logical processor”) per core.

FIG. 6 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 40 (FIG. 2), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 6, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

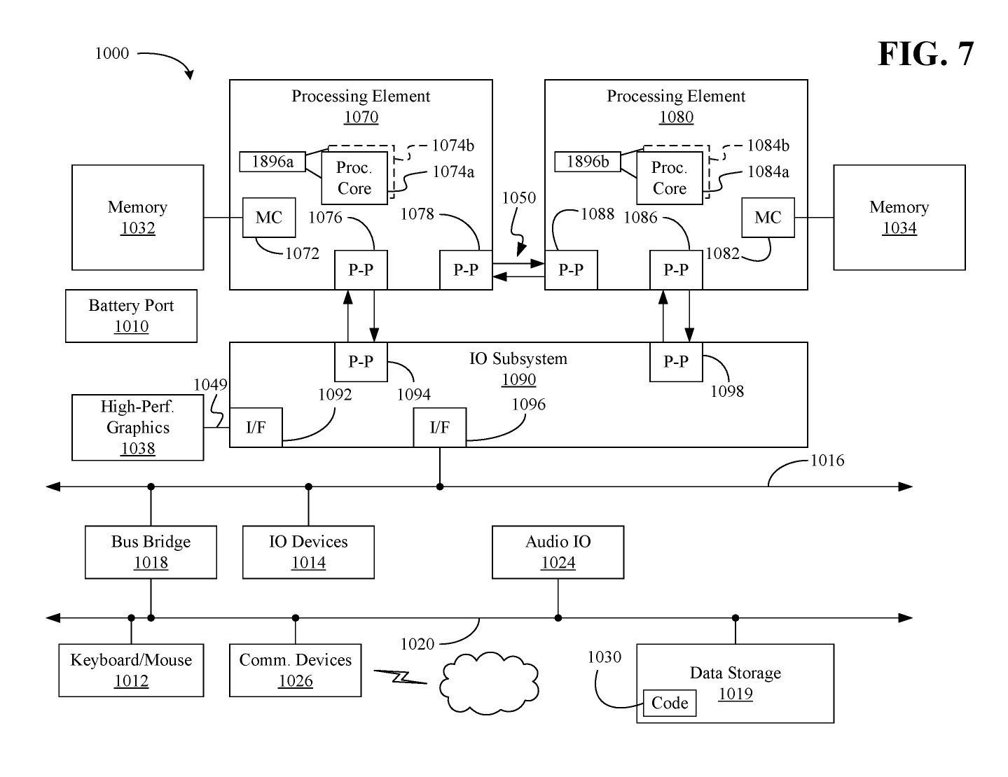

Referring now to FIG. 7, shown is a block diagram of a computing system 1000 embodiment in accordance with an embodiment. Shown in FIG. 7 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 7 may be implemented as a multi-drop bus rather than point-to-point interconnect.

As shown in FIG. 7, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 6.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 7, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 7, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 7, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 40 (FIG. 2), already discussed, and may be similar to the code 213 (FIG. 6), already discussed. Further, an audio I/O 1024 may be coupled to second bus 1020 and a battery port 1010 may supply power to the computing system 1000.

Note that other embodiments are contemplated. For example, instead of the point-to-point architecture of FIG. 7, a system may implement a multi-drop bus or another such communication topology. Also, the elements of FIG. 7 may alternatively be partitioned using more or fewer integrated chips than shown in FIG. 7.

### ADDITIONAL NOTES AND EXAMPLES

Example 1 may include an authentication-enabled computing device comprising a battery port, a hardware-based trusted execution environment (TEE) to store an encryption key, and an archival recovery apparatus including an authentication manager to generate, at the computing device, a challenge message in response to a recovery request, and a dynamic application loader communicatively coupled to the authentication manager, the dynamic application loader to conduct a verification of one or more responses to the challenge message based on the encryption key and unlock an authentication template associated with a multifactor authentication service if the verification is successful.

Example 2 may include the computing device of Example 1, wherein the dynamic application loader is to one or more of retrieve the authentication template from the hardware-based TEE or update the authentication template in the hardware-based TEE.

Example 3 may include the computing device of any one of Examples 1 or 2, further including a display, and a trusted path communicatively coupled to the display and the hardware-based TEE, wherein the authentication manager is to present the challenge message on the display via the trusted path.

Example 4 may include the computing device of Example 3, wherein the dynamic application loader is to receive the one or more responses from one or more backend consoles.

Example 5 may include the computing device of Example 3, further including an input device, wherein the dynamic application loader is to receive the one or more responses from the input device and map the one or more responses to a protected area of the display.

Example 6 may include the computing device of any one of Examples 1 or 2, wherein the dynamic application loader is to receive a plurality of responses from a corresponding plurality of peer devices via one or more proximity-based out-of-band communication links, and wherein the verification is to be conducted with respect to the plurality of responses and the authentication template is to be unlocked if the plurality of responses satisfy a secret sharing policy with respect to the encryption key.

Example 7 may include an archival recovery apparatus comprising an authentication manager to generate, at a computing device, a challenge message in response to a recovery request and a dynamic application loader communicatively coupled to the authentication manager, the dynamic application loader to conduct a verification of one or more responses to the challenge message based on an encryption key stored in a hardware-based trusted execution environment (TEE) of the computing device and unlock an authentication template associated with a multifactor authentication service if the verification is successful.

Example 8 may include the apparatus of Example 7, wherein the dynamic application loader is to one or more of retrieve the authentication template from the hardware-based TEE or update the authentication template in the hardware-based TEE.

Example 9 may include the apparatus of any one of Examples 7 or 8, wherein the authentication manager is to present the challenge message on a display of the computing device via a trusted path.

Example 10 may include the apparatus of Example 9, wherein the dynamic application loader is to receive the one or more responses from one or more backend consoles.

Example 11 may include the apparatus of Example 9, wherein the dynamic application loader is to receive the one or more responses from an input device of the computing device and map the one or more responses to a protected area of the display.

Example 12 may include the apparatus of any one of Examples 7 or 8, wherein the dynamic application loader is to receive a plurality of responses from a corresponding plurality of peer devices via one or more proximity-based out-of-band communication links, and wherein the verification is to be conducted with respect to the plurality of responses and the authentication template is to be unlocked if the plurality of responses satisfy a secret sharing policy with respect to the encryption key.

Example 13 may include a method of operating an archival recovery apparatus, comprising generating, at a computing device, a challenge message in response to a recovery request, conducting a verification of one or more responses to the challenge message based on an encryption key stored in a hardware-based trusted execution environment (TEE) of the computing device, and unlocking an authentication template associated with a multifactor authentication service if the verification is successful.

Example 14 may include the method of Example 13, wherein unlocking the authentication template includes one or more of retrieving the authentication template from the hardware-based TEE, or updating the authentication template in the hardware-based TEE.

Example 15 may include the method of any one of Examples 13 or 14, wherein generating the challenge message includes presenting the challenge message on a display of the computing device via a trusted path.

Example 16 may include the method of Example 15, further including receiving the one or more responses from one or more backend consoles.

Example 17 may include the method of Example 15, further including receiving the one or more responses from an input device of the computing device, and mapping the one or more responses to a protected area of the display.

Example 18 may include the method of any one of Examples 13 or 14, further including receiving a plurality of responses from a corresponding plurality of peer devices via one or more proximity-based out-of-band communication links, wherein the verification is conducted with respect to the plurality of responses and the authentication template is unlocked if the plurality of responses satisfy a secret sharing policy with respect to the encryption key.

Example 19 may include at least one computer readable storage medium comprising a set of instructions, which when executed by a computing device, cause the computing device to generate, at the computing device, a challenge message in response to a recovery request, conduct a verification of one or more responses to the challenge message based on an encryption key stored in a hardware-based trusted execution environment (TEE) of the computing device, and unlock an authentication template associated with a multifactor authentication service if the verification is successful.

Example 20 may include the at least one computer readable storage medium of Example 19, wherein the instructions, when executed, cause the computing device to one or more of retrieve the authentication template from the hardware-based TEE, or update the authentication template in the hardware-based TEE.

Example 21 may include the at least one computer readable storage medium of any one of Examples 19 or 20, wherein the instructions, when executed, cause the computing device to present the challenge message on a display of the computing device via a trusted path.

Example 22 may include the at least one computer readable storage medium of Example 21, wherein the instructions, when executed, cause the computing device to receive the one or more responses from one or more backend consoles.

Example 23 may include the at least one computer readable storage medium of Example 21, wherein the instructions, when executed, cause the computing device to receive the one or more responses from an input device of the computing device, and map the one or more responses to a protected area of the display.

Example 24 may include the at least one computer readable storage medium of any one of Examples 19 or 20, wherein the instructions, when executed, cause the computing device to receive a plurality of responses from a corresponding plurality of peer devices via one or more proximity-based out-of-band communication links, and wherein the verification is to be conducted with respect to the plurality of responses and the authentication template is to be unlocked if the plurality of responses satisfy a secret sharing policy with respect to the encryption key.

Example 25 may include an archival recovery apparatus comprising means for generating, at a computing device, a challenge message in response to a recovery request, means for conducting a verification of one or more responses to the challenge message based on an encryption key stored in a hardware-based trusted execution environment (TEE) of the computing device, and means for unlocking an authentication template associated with a multifactor authentication service if the verification is successful.

Example 26 may include the apparatus of Example 25, wherein the means for unlocking the authentication template includes one or more of means for retrieving the authentication template from the hardware-based TEE, or means for updating the authentication template in the hardware-based TEE.

Example 27 may include the apparatus of any one of Examples 25 or 26, wherein the means for generating the challenge message includes means for presenting the challenge message on a display of the computing device via a trusted path.

Example 28 may include the apparatus of Example 27, further including means for receiving the one or more responses from one or more backend consoles.

Example 29 may include the apparatus of Example 27, further including means for receiving the one or more responses from an input device of the computing device, and means for mapping the one or more responses to a protected area of the display.

Example 30 may include the apparatus of any one of Examples 25 or 26, further including means for receiving a plurality of responses from a corresponding plurality of peer devices via one or more proximity-based out-of-band communication links, wherein the verification is to be conducted with respect to the plurality of responses and the authentication template is to be unlocked if the plurality of responses satisfy a secret sharing policy with respect to the encryption key.

Thus, techniques described herein may enhance the end-user experience through simple PIN entry that enables the user to re-enroll lost/forgotten authentication factors. Moreover, PIN protection and verification may be fully protected (e.g., “hardened”) in HW/FW with user presence detection. Additionally, easy yet secure and fast recovery may be achieved. Techniques described herein may also provide the ability for hardware-based TEEs to maintain a recovery credential (e.g., PIN) that is protected by the TEE storage root key. Moreover, the recovery credential may be protected by preventing the TEE from booting if it is stolen (e.g., via anti-theft technology) or additionally wrapping the recovery credential by a value not found on the platform (e.g., a password derived wrapping key). In addition, secret sharing may enable offline recovery scenarios that benefit from proximity-based (e.g., physical) authentication.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing device comprising:
a battery port;
a hardware-based trusted execution environment (TEE) to store an encryption key; and
an archival recovery apparatus including,
an authentication manager to generate, at the computing device, a challenge message in response to a recovery request, and
a dynamic application loader communicatively coupled to the authentication manager, the dynamic application loader to conduct a verification of one or more responses to the challenge message based on the encryption key and unlock an authentication template associated with a multifactor authentication service if the verification is successful.

2. The computing device of claim 1, wherein the dynamic application loader is to one or more of retrieve the authentication template from the hardware-based TEE or update the authentication template in the hardware-based TEE.

3. The computing device of claim 1, further including:
a display; and
a trusted path communicatively coupled to the display and the hardware-based TEE, wherein the authentication manager is to present the challenge message on the display via the trusted path.

4. The computing device of claim 3, wherein the dynamic application loader is to receive the one or more responses from one or more backend consoles.

5. The computing device of claim 3, further including an input device, wherein the dynamic application loader is to receive the one or more responses from the input device and map the one or more responses to a protected area of the display.

6. The computing device of claim 1, wherein the dynamic application loader is to receive a plurality of responses from a corresponding plurality of peer devices via one or more proximity-based out-of-band communication links, and wherein the verification is to be conducted with respect to the plurality of responses and the authentication template is to be unlocked if the plurality of responses satisfy a secret sharing policy with respect to the encryption key.

7. An apparatus comprising:
an authentication manager to generate, at a computing device, a challenge message in response to a recovery request; and
a dynamic application loader communicatively coupled to the authentication manager, the dynamic application loader to conduct a verification of one or more responses to the challenge message based on an encryption key stored in a hardware-based trusted execution environment (TEE) of the computing device and unlock an authentication template associated with a multifactor authentication service if the verification is successful.

8. The apparatus of claim 7, wherein the dynamic application loader is to one or more of retrieve the authentication template from the hardware-based TEE or update the authentication template in the hardware-based TEE.

9. The apparatus of claim 7, wherein the authentication manager is to present the challenge message on a display of the computing device via a trusted path.

10. The apparatus of claim 9, wherein the dynamic application loader is to receive the one or more responses from one or more backend consoles.

11. The apparatus of claim 9, wherein the dynamic application loader is to receive the one or more responses from an input device of the computing device and map the one or more responses to a protected area of the display.

12. The apparatus of claim 7, wherein the dynamic application loader is to receive a plurality of responses from a corresponding plurality of peer devices via one or more proximity-based out-of-band communication links, and wherein the verification is to be conducted with respect to the plurality of responses and the authentication template is to be unlocked if the plurality of responses satisfy a secret sharing policy with respect to the encryption key.

13. A method comprising:
generating, at a computing device, a challenge message in response to a recovery request;
conducting a verification of one or more responses to the challenge message based on an encryption key stored in a hardware-based trusted execution environment (TEE) of the computing device; and
unlocking an authentication template associated with a multifactor authentication service if the verification is successful.

14. The method of claim 13, wherein unlocking the authentication template includes one or more of:
retrieving the authentication template from the hardware-based TEE; or
updating the authentication template in the hardware-based TEE.

15. The method of claim 13, wherein generating the challenge message includes presenting the challenge message on a display of the computing device via a trusted path.

16. The method of claim 15, further including receiving the one or more responses from one or more backend consoles.

17. The method of claim 15, further including:
receiving the one or more responses from an input device of the computing device; and
mapping the one or more responses to a protected area of the display.

18. The method of claim 13, further including receiving a plurality of responses from a corresponding plurality of peer devices via one or more proximity-based out-of-band communication links, wherein the verification is conducted with respect to the plurality of responses and the authentication template is unlocked if the plurality of responses satisfy a secret sharing policy with respect to the encryption key.

19. At least one computer readable storage medium comprising a set of instructions, which when executed by a computing device, cause the computing device to:
generate, at the computing device, a challenge message in response to a recovery request;
conduct a verification of one or more responses to the challenge message based on an encryption key stored in a hardware-based trusted execution environment (TEE) of the computing device; and
unlocking an authentication template associated with a multifactor authentication service if the verification is successful.

20. The at least one computer readable storage medium of claim 19, wherein the instructions, when executed, cause the computing device to one or more of:
retrieve the authentication template from the hardware-based TEE; or
update the authentication template in the hardware-based TEE.

21. The at least one computer readable storage medium of claim 19, wherein the instructions, when executed, cause the computing device to present the challenge message on a display of the computing device via a trusted path.

22. The at least one computer readable storage medium of claim 21, wherein the instructions, when executed, cause the computing device to receive the one or more responses from one or more backend consoles.

23. The at least one computer readable storage medium of claim 21, wherein the instructions, when executed, cause the computing device to:
receive the one or more responses from an input device of the computing device; and
map the one or more responses to a protected area of the display.

24. The at least one computer readable storage medium of claim 19, wherein the instructions, when executed, cause the computing device to receive a plurality of responses from a corresponding plurality of peer devices via one or more proximity-based out-of-band communication links, and wherein the verification is to be conducted with respect to the plurality of responses and the authentication template is to be unlocked if the plurality of responses satisfy a secret sharing policy with respect to the encryption key.
